(19) United States
(12) Patent Application Publication
(10) Pub. No.: US 2014/0191102 A1
(43) Pub. Date: Jul. 10, 2014

(54) ADJUSTABLE STAND HOLDER

(71) Applicant: CHEN-SOURCE INC., Taoyuan County (TW)

(72) Inventor: Wei-Ting LIN, Taoyuan County (TW)

(73) Assignee: CHEN-SOURCE INC., Taoyuan County (TW)

(21) Appl. No.: 13/738,772

(22) Filed: Jan. 10, 2013

(51) Int. Cl. F16M 11/10

(52) U.S. Cl. CPC F16M 11/10
USPC 248/454

(57) ABSTRACT

An adjustable stand holder includes a stand base including a base frame, an axle holder and a guide track arranged at the base frame at right angles, a cover member including a cover frame pivotally coupled to the axle holder and a smoothly curved stop flange raised from a front side of the cover frame for supporting a mobile electronic device on the cover frame, and a wheel receivable in the stand base and mountable between the base frame and cover frame to support the cover member in a tilted position relative to the stand base and movable along the guide track to adjust the tilting angle of the cover member relative to the stand base.

### BACKGROUND OF THE INVENTION

1. Field of the Invention

The present invention relates to device stand technology and more particularly, to an adjustable stand holder, which is practical for use to support a mobile electronic device on the top of a table or desk in a tilted position and allows adjustment of the tilting angle of the supported mobile electronic device within a predetermined range of angles

2. Description of the Related Art

With fast development of electronic and multimedia information technologies, smart phones, tablet computers, PDAs and many different advanced mobile electronic devices have been created and have appeared on the market. These advances mobile electronic devices have light, thin, short and small characteristics. Further, with the support of high-power software, these advances mobile electronic devices have been intensively used by people of different ages for working, entertainment and many other different purposes.

When using a mobile electronic device, the user may directly hold the mobile electronic device in hand. However, because a mobile electronic device has a certain weight, holding it in hand for a long period time can cause stiffness and pain in the hand (such as carpal tunnel syndrome), back pain, or spine injury. To avoid this problem, stand holders are created for use to support a mobile electronic device on the top of a table or desk.

FIG. 8 illustrates a stand holder according to the prior art. According to this design, the stand holder comprises a base panel A, a smoothly arched stop flange A1 raised from one end of the base panel A, a support block A2 located at the other end of the base panel A to hold the base panel A in a sloping angle and defining therein an accommodation hole A21, and a roller B receivable in the accommodation hole A21. The roller B can be taken out of the accommodation hole A21 and placed on the top side of the base panel A to support a mobile electronic device C on the base panel A against the smoothly arched stop flange A1 in a tilted position.

The aforesaid design allows the user to adjust the tilted angle of the supported mobile electronic device C by moving the roller B along the base panel A. However, when the roller B is moved relatively closer to the smoothly arched stop flange A1, the roller B will give a relatively larger pressure to the supported mobile electronic device C. Touching the touchscreen of the supported mobile electronic device C at this time will cause stress concentration, damaging the supported mobile electronic device C. Further, because the contact surface area between the roller B and the supported mobile electronic device C is limited, the supported mobile electronic device C may fall from the stand holder to the table or desk, or the floor, causing severe damage.

### SUMMARY OF THE INVENTION

The present invention has been accomplished under the circumstances in view. It is the main object of the present invention to provide an adjustable stand holder, which is practical for use to support a mobile electronic device on the top of a table or desk in a tilted position and allows adjustment of the tilting angle of the supported mobile electronic device within a predetermined range of angles.

To achieve this and other objects of the present invention, an adjustable stand holder comprises a stand base, a cover member and at least one wheel. The stand base comprises a base frame, an axle holder mounted at the base frame in a first direction, and at least one guide track arranged at the base frame in a second direction perpendicular to the first direction. The cover member comprises a cover frame pivotally coupled to the axle holder, and a smoothly curved stop flange raised from a front side of the cover frame for supporting a mobile electronic device on the cover frame. The at least one wheel is receivable in the base frame of the stand base. Further, each wheel can be set between the base frame and cover frame to support the cover member in a tilted position relative to the stand base, and moved along one respective guide track to adjust the tilting angle of the cover member relative to the stand base. Subject to the length design of the at least one guide track, the cover member can be biased relative to the stand base to define a contained angle within the range of 12˜70° angle.

Further, each wheel comprises a metal circular wheel body defining a rim around an outer perimeter thereof, and an anti-slip covering mounted around the metal circular wheel body and stopped in place by the rim. The anti-slip covering comprises a locating groove forced into engagement with the rim. Further, the anti-slip covering is preferably made out of flexible rubber, having a toothed pattern formed in the outer wall thereof to enhance friction resistance with the cover member and the stand base.

Further, the cover member comprises at least one longitudinal locating rib located at the bottom side of the cover frame corresponding to the at least one guide track for guiding movement of each wheel stably along each respective guide track, avoiding vibration.

Further, the cover member comprises a bottom recessed hole located at the bottom side of the cover frame for receiving the axle holder of the stand base. Thus, when the cover member is closed on the stand base, the adjustable stand holder is kept in a flat condition, reducing the height and saving storage space. Further, the cover member comprises an opening cut through the cover frame. Further, the stand base comprises an opening cut through the base frame. Subject to the design of the opening of the stand base and the opening of the cover member, the weight and material consumption of the adjustable stand holder can be greatly reduced, convenient for carrying.

### BRIEF DESCRIPTION OF THE DRAWINGS

FIG. 1 is an elevational view of an adjustable stand holder in accordance with the present invention.

FIG. 2 is an exploded view of the adjustable stand holder in accordance with the present invention.

FIG. 3 corresponds to FIG. 2 when viewed from another angle.

FIG. 4 is an elevational view of the present invention, illustrating the wheel set between the high front low back bottom wall of the cover member and the rear end of the sliding groove of one guide track of the stand base.

FIG. 5 corresponds to FIG. 4, illustrating the wheel moved to the front end of the sliding groove of the guide track of the stand base.

FIG. 6 is a schematic sectional side view of FIG. 5.

FIG. 7 is an applied view of the present invention.

FIG. 8 illustrates an application example of a stand holder according to the prior art.

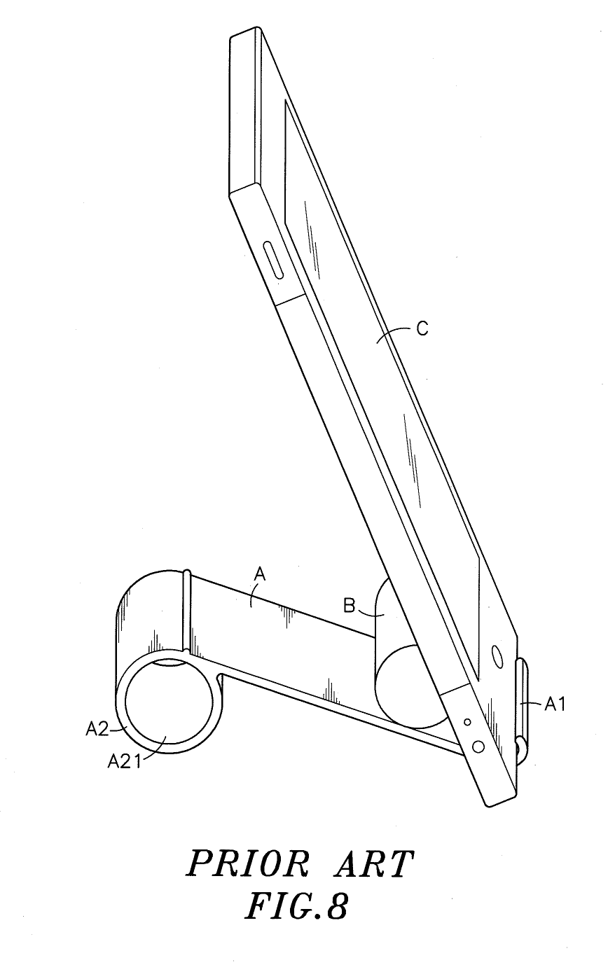

### DETAILED DESCRIPTION OF THE PREFERRED EMBODIMENT

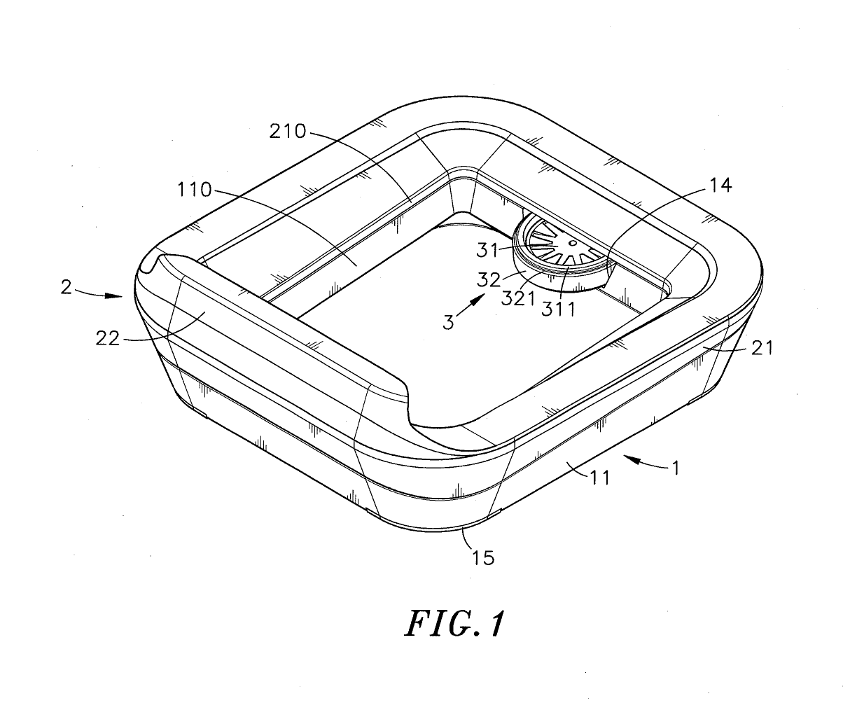

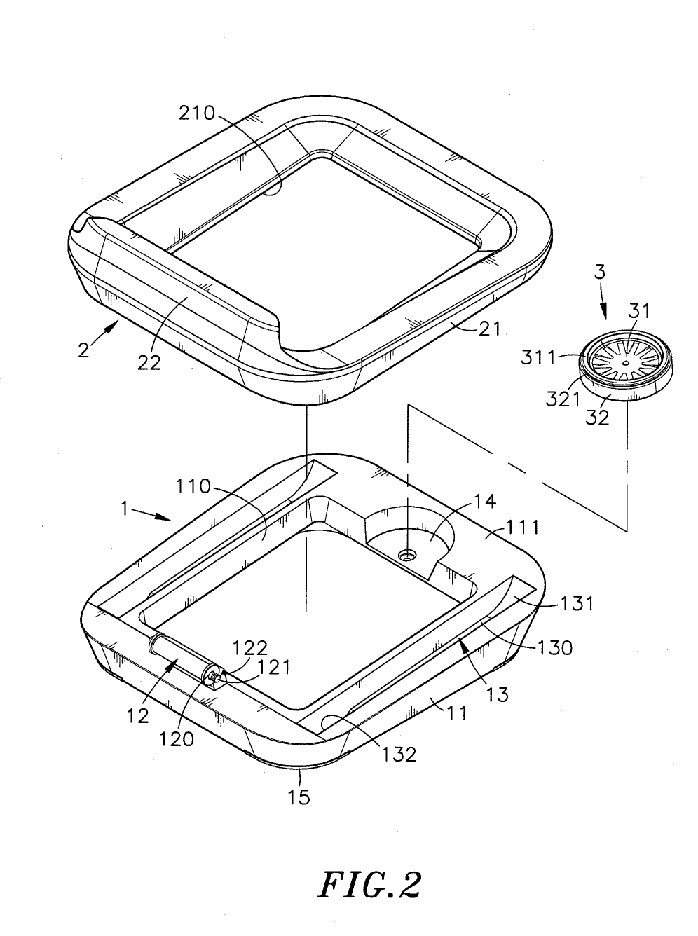

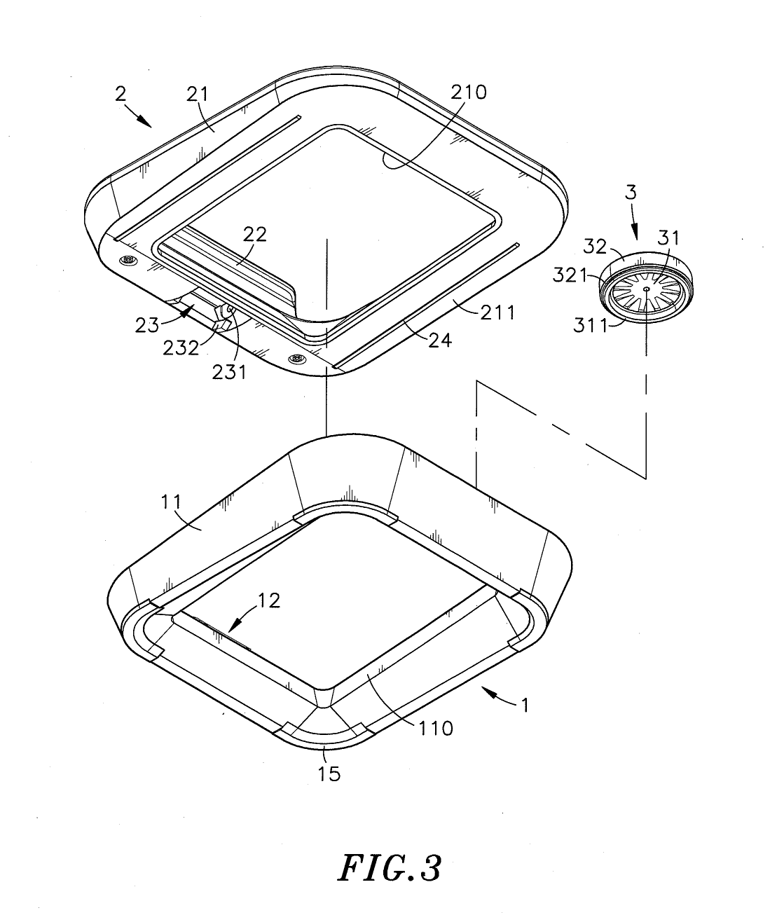

Referring to FIGS. 1-3, an adjustable stand holder in accordance with the present invention is shown. The adjustable stand holder comprises a stand base 1, a cover member 2, and at least one wheel 3.

The stand base 1 comprises a base frame 11 defining a high front low back top wall 111, an opening 110 cut through the base frame 11 and surrounded by the high front low back top wall 111, an accommodation chamber 14 formed in the high front low back top wall 111 in a middle rear position relative to and in communication with the opening 110, an axle holder 12 transversely mounted at the high front low back top wall 111 in a middle front position relative to the opening 110 and opposite to the accommodation chamber 14 and defining therein an axial hole 120, a rotary axle 121 inserted through the axial hole 120 of the axle holder 12 and defining a locating notch 122 on the periphery of each of two opposite ends thereof, at least one, for example, two guide tracks 13 formed in the high front low back top wall 111 at two opposite lateral sides of the opening 110 in a parallel manner, and a plurality of cushion pads 15 mounted in corners of the bottom side of the base frame 11. Further, each guide track 13 defines a sliding groove 130, two smoothly arched bearing surfaces 131 respectively located at opposing front and rear ends of the sliding groove 130, and a positioning groove 132 formed in the smoothly arched bearing surface 131 at the front end of the sliding groove 130.

The cover member 2 comprises a cover frame 21 defining a high front low back bottom wall 211, an opening 210 cut through the cover frame 21 and surrounded by the high front low back bottom wall 211, a smoothly curved stop flange 22 raised from the top surface of the cover frame 21 at a front side relative to the opening 210, a bottom recessed hole 23 located at the high front low back bottom wall 211 of the cover frame 21 corresponding to the smoothly curved stop flange 22, two axle holes 231 formed in the cover frame 21 at two opposite lateral sides of the bottom recessed hole 23 and aligned in line, two stop blocks 232 bilaterally disposed in the bottom recessed hole 23 and spaced below the axle holes 231, and at least one, for example, two longitudinal locating ribs 24 protruded from the high front low back bottom wall 211 and extending in a parallel manner at two opposite lateral sides relative to the opening 210.

The wheel 3 comprises a metal circular wheel body 31 defining a rim 311 around an outer perimeter thereof, and an anti-slip covering 32 mounted around the metal circular wheel body 31 and stopped in place by the rim 311. Further, the anti-slip covering 32 defines a locating groove 321 that is forced into engagement with the rim 311. The anti-slip covering 32 can be made out of flexible rubber, having a toothed pattern formed in the outer wall thereof.

When assembling the adjustable stand holder, pivotally connect the cover frame 21 of the cover member 2 to the axle holder 12 of the stand base 1 by: moving the axle holder 12 of the stand base 1 into the bottom recessed hole 23 of the cover member 2 and then coupling the two opposite ends of the rotary axle 121 of the stand base 1 to the axle holes 231 of the cover member 2. At this time, the cover member 2 can be biased relative to the stand base 1 to a limited angle where the locating notches 122 of the axle holder 12 of the stand base 1 are respectively abutted against the stop blocks 232 of the cover member 2. Further, when biasing the cover member 2 relative to the stand base 1, an open space 20 will be defined between the stand base 1 and the cover member 2. Further, when the adjustable stand holder is not in use, the wheel 3 can be received in the accommodation chamber 14 in the stand base 1. Further, the accommodation chamber 14 can have a circular or semi-circular profile fitting the configuration of the wheel 3. Further, when the cover member 2 is closed on the stand base 1, the high front low back bottom wall 211 of the cover frame 21 and the high front low back top wall 111 of the base frame 11 are abutted against each other, and therefore the adjustable stand holder is kept in a flat condition, reducing the height and saving storage space. Subject to the design of the opening 110 of the stand base 1 and the opening 210 of the cover member 2, the weight and material consumption of the adjustable stand holder can be greatly reduced, convenient for carrying.

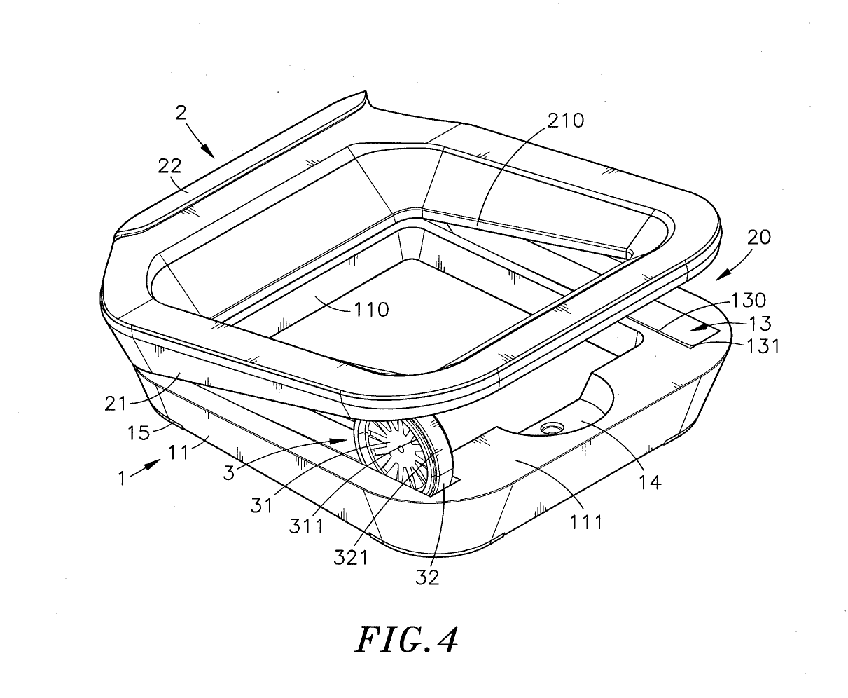

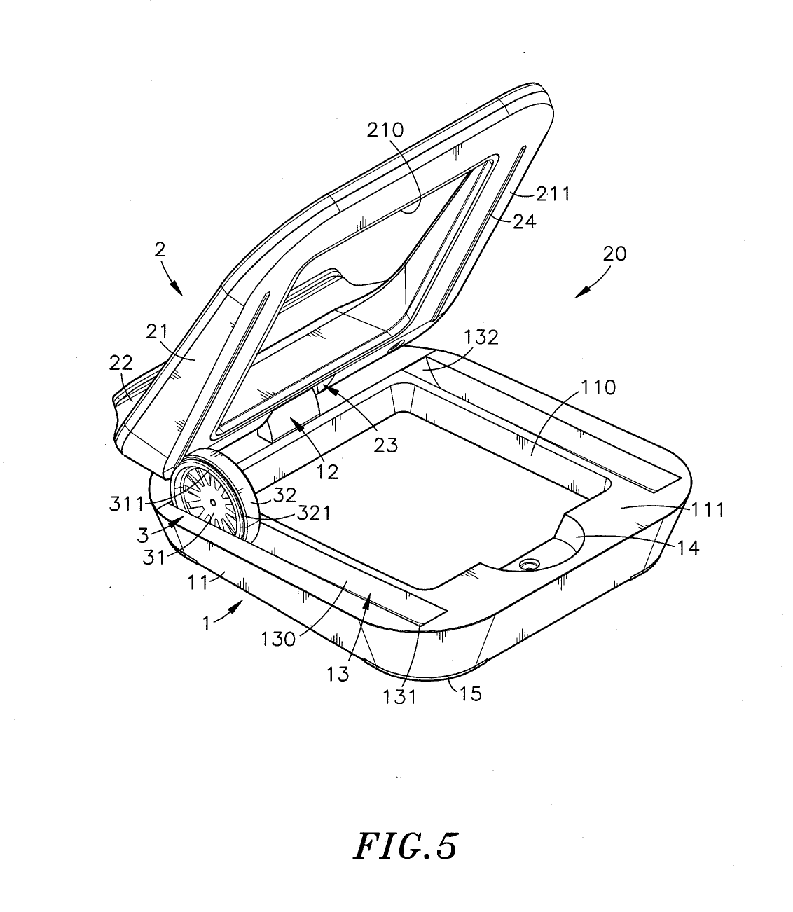

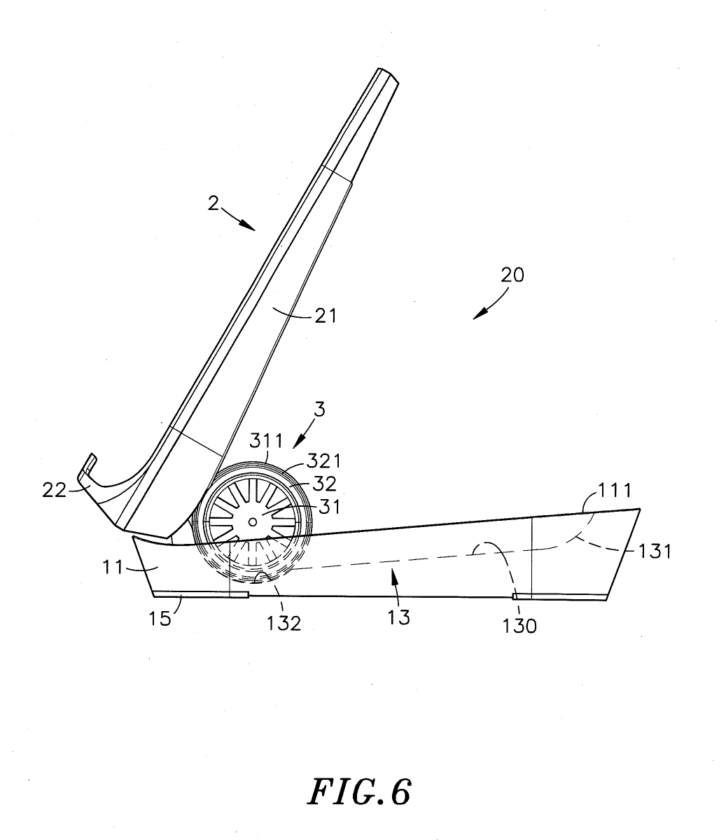

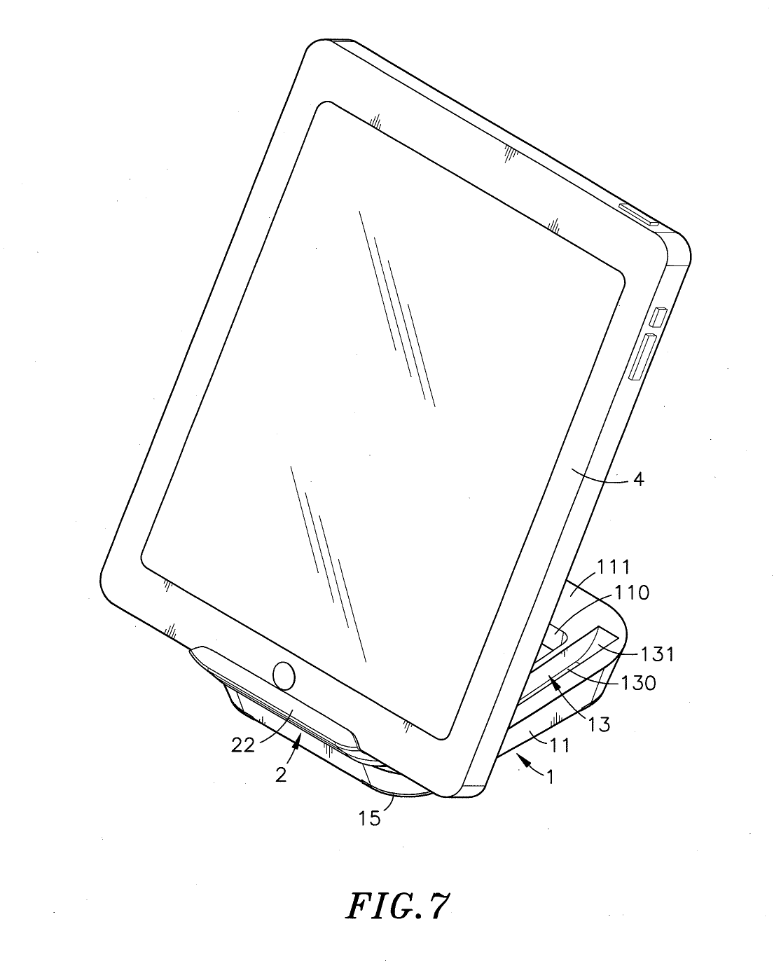

Referring to FIGS. 4-7, when using the adjustable stand holder, the adjustable stand holder can be placed on the top of a table or desk, keeping the cushion pads 15 in positive contact with the surface of the top of the table or desk. At this time, a mobile electronic device 4 (such as tablet computer, smart phone, PDA, multimedia player, etc.) can be supported on the cover frame 21 and smoothly curved stop flange 22 of the cover member 2.

When going to adjust the angular position of the adjustable stand holder, lift the rear side of the cover member 2 to turn the cover member 2 about the axle holder 12 of the stand base 1, and then take the wheel 3 out of the accommodation chamber 14, and then insert the wheel 13 into the sliding groove 130 of one guide track 13 and move the wheel 13 to the positioning groove 132 at the front end of the sliding groove 130, and then lower the cover member 2 to let the high front low back bottom wall 211 of the cover frame 21 be supported on the wheel 3. At this time, the wheel 3 supports the cover member 2 and the mobile electronic device 4 on the stand base 1 in a tilted position. By means of moving the wheel 3 in the sliding groove 130 of the respective guide track 13, the tilting angle of the cover member 2 and the mobile electronic device 4 is relatively adjusted. Further, the wheel 3 can be moved between the front and rear ends of the sliding groove 130 of the respective guide track 13 to adjust the tilting angle of the cover member 2 and the mobile electronic device 4 (the contained angle between stand base 1 and the cover member 2) within 12˜70° angle. By means of adjusting the tilting angle of the cover member 2 and the mobile electronic device 4 subject to user's preference, the user can touch the touchscreen of the mobile electronic device 4 comfortably.

Further, when adjusting the tilting angle of the cover member 2, the high front low back bottom wall 211 of the cover frame 21 of the cover member 2 is kept in friction engagement with the anti-slip covering 32 of the wheel 3, avoiding slipping. Further, the rim 311 of the metal circular wheel body 31 of the wheel 3 is kept abutted against one longitudinal locating rib 24 of the cover member 2, enhancing positioning stability and avoiding vibration.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An adjustable stand holder, comprising:
a stand base comprising a base frame, an axle holder mounted at said base frame near a front side thereof and extending in a first direction, and at least one guide track located at said base frame and extending in a second direction perpendicular to said first direction;
a cover member comprising a cover frame pivotally coupled to said axle holder for supporting a mobile electronic device and biasable relative to said stand base to define a contained angle between said stand base and said cover member, and a smoothly curved stop flange raised from a front side of said cover frame for stopping a mobile electronic device on said cover frame; and
at least one wheel mountable between said stand base and said cover member to support said cover member in a tilted position relative to said stand base and movable along said at least one guide track to adjust the tilting angle of said cover member relative to said stand base.

2. The adjustable stand holder as claimed in claim 1, wherein said base frame comprises a high front low back top wall, and an opening surrounded by said high front low back top wall; said cover frame of said cover member comprises a high front low back bottom wall, and an opening surrounded by said high front low back bottom wall.

3. The adjustable stand holder as claimed in claim 1, wherein said axle holder supports therein a rotary axle; said cover member further comprises a bottom recessed hole located at a bottom side of said cover frame, and two axle holes formed in said cover frame at two opposite lateral sides of said bottom recessed hole and respectively coupled to two opposite ends of said rotary axle of said axle holder.

4. The adjustable stand holder as claimed in claim 3, wherein said rotary axle comprises a locating notch on the periphery of each of two opposite ends thereof; said cover member further comprises two stop blocks bilaterally disposed in said bottom recessed hole and spaced below said axle holes for stopping against said locating notches.

5. The adjustable stand holder as claimed in claim 1, wherein each said guide track defines a sliding groove, two smoothly arched bearing surfaces respectively located at opposing front and rear ends of said sliding groove, and a positioning groove formed in the smoothly arched bearing surface at the front end of said sliding groove.

6. The adjustable stand holder as claimed in claim 1, wherein said cover member further comprises an accommodation chamber formed in said cover frame for accommodating said at least one wheel.

7. The adjustable stand holder as claimed in claim 1, wherein said cover member further comprises a bottom recessed hole located at a bottom side of said cover frame and coupled to said axle holder of said stand base, and at least one longitudinal locating rib located at the bottom side of said cover frame corresponding to said at least one guide track; each said wheel comprises a metal circular wheel body defining a rim around an outer perimeter thereof and stoppable at one said longitudinal locating rib.

8. The adjustable stand holder as claimed in claim 1, wherein each said wheel comprises a metal circular wheel body defining a rim around an outer perimeter thereof, and an anti-slip covering mounted around said metal circular wheel body and stopped in place by said rim, said anti-slip covering comprising a locating groove forced into engagement with said rim.

9. The adjustable stand holder as claimed in claim 8, wherein said anti-slip covering is made out of flexible rubber.

10. The adjustable stand holder as claimed in claim 8, wherein said anti-slip covering comprises a toothed pattern formed in an outer wall thereof.
